(19) United States
(12) Patent Application Publication
(10) Pub. No.: US 2025/0328379 A1
(43) Pub. Date: Oct. 23, 2025

(54) DYNAMIC UNRELATED PARALLEL MACHINE SCHEDULING (UPMS) WITH WEIGHTED JOBS AND BALANCED LOADS

(71) Applicant: JPMorgan Chase Bank, N.A., New York, NY (US)

(72) Inventors: Ebrahim Mortaz, New York, NY (US); Grant M Turner, LONDON (GB); Abhishek Shah, Vadodara (IN); Soumit Malkar, Mumbai Suburban (IN); Simon Villet, Lewes (GB); Remi Gazalet, London (GB); Biswa Sengupta, LONDON (GB); Stuart Jackson, Jersey City, NJ (US)

(73) Assignee: JPMorgan Chase Bank, N.A., New York, NY (US)

(21) Appl. No.: 18/679,851

(22) Filed: May 31, 2024

(30) Foreign Application Priority Data
Apr. 18, 2024 (IN) 202411031131

(51) Int. Cl. G06F 9/48

(52) U.S. Cl. CPC G06F 9/4881

(57) ABSTRACT

Aspects of the subject disclosure may include, for example, receiving information regarding a plurality of jobs, assigning the plurality of jobs to a plurality of workers in accordance with a base schedule, wherein the base schedule is derived by solving an initial scheduling model that is configured to facilitate job assignments based on worker availability, capabilities, skills, experience, or a combination thereof, while reducing or minimizing job completion time and maintaining a determined balanced load, detecting one or more disruptions or events after the assigning, and causing the base schedule to be repaired based on the detecting, wherein the causing involves solving a scheduling repairing model that is configured to repair an existing schedule based on detected disruptions or events, while reducing or minimizing an impact of the detected disruptions or events on the existing schedule. Other embodiments are disclosed.

### CROSS-REFERENCE TO RELATED APPLICATION

The present application claims priority to Indian Patent Application number 202411031131 filed on Apr. 18, 2024. All sections of the aforementioned application are incorporated herein by reference in their entirety.

### FIELD OF THE DISCLOSURE

The subject disclosure relates to dynamic unrelated parallel machine scheduling (UPMS) with weighted jobs and balanced loads.

### BACKGROUND

UPMS entails the optimal assignment of jobs or tasks with diverse processing requirements to a pool of heterogeneous machines or people (or, more generally, workers). Real-world finance settings where this computational problem is relevant include widespread functions across most lines of business—e.g., fraud/sanctions screening, information technology (IT) helpdesk staffing, or operations processes such as trade settlements.

### BRIEF DESCRIPTION OF THE DRAWINGS

Reference will now be made to the accompanying drawings, which are not necessarily drawn to scale, and wherein:

FIG. 1A is a block diagram of an example, non-limiting embodiment of UPMS in accordance with various aspects described herein.

FIG. 1B shows an example of a high-level dynamic scheduling scheme in accordance with various aspects described herein.

FIG. 2A shows an example jump selection distribution where self-learning is implemented, in accordance with various aspects described herein.

FIG. 2B shows jump samples taken from a uniform distribution of jumps where self-learning is not implemented.

FIGS. 2C-2H show cost comparisons (for five workers, ten workers, twenty workers, thirty workers, forty workers, and fifty workers, respectively) in cases where self-learning is employed versus where self-learning is not employed.

FIG. 2I shows a cost comparison in a case where a custom head start (w/head start) is employed versus where a random start (w/o a head start) is employed.

FIGS. 2J-2M show cost comparisons (for the two worker scenario, five worker scenario, ten worker scenario, and twenty worker scenario, respectively) that illustrate the lower cost (particularly as the number of generations increases) provided by a genetic algorithm (GA) relative to Weng's upper bound.

FIGS. 2N-2Q demonstrate an example flow of dynamic UPMS in accordance with various aspects described herein.

FIG. 3 depicts an illustrative embodiment of a method in accordance with various aspects described herein.

FIG. 4 is a block diagram of an example, non-limiting embodiment of a computing environment in accordance with various aspects described herein.

### DETAILED DESCRIPTION

Each day, a financial firm may process thousands of trade settlements, many of which may require intensive manual intervention where substantial value is at risk in the form of penalties, etc. if a trade fails or does not settle by the end of the contractual settlement date. It can be challenging for a manager to determine how to best allocate settlements tasks to individual members of a settlements team (taking into consideration individual skills and day-to-day capacity constraints), and it can be especially challenging for the manager to do so dynamically (e.g., following sudden market shifts). Indeed, this can become a high-dimensional problem very quickly, with perhaps many billions of possibilities for even small teams/task sets. Analogous situations arise in other team domains at a firm, such as, for instance, fraud or error payment investigation teams.

It is believed that UPMS and related problems have been relatively poorly resolved in the theoretical literature, with even applied solutions being predominantly limited to heuristic approaches. An ideal objective of UPMS, that aims to penalize tardiness, is to seek to minimize the expected total weighted completion time while maintaining balanced machine loads. However, the problem is inherently challenging for several reasons:
(a) heterogenous machines/people—where managing workers with varying capabilities (skills/processing speeds) requires intricate job assignments to optimize end goal(s);
(b) dynamic environment—where the presence of disruptions, such as new job arrival, completed jobs, machine unavailability, job reworks, very important person (VIP) jobs, and management interventions on assignment, makes the scheduling environment highly dynamic and unpredictable;
(c) optimization goals—where balancing the competing goals of minimizing total completion time, efficient resource allocation, minimizing disruption impacts, and load balancing requires a sophisticated scheduling algorithm with high maneuverability;
(d) real-time adaptation—where responding to real-time adaptations and changing conditions add an additional layer of complexity to the scheduling strategies; and
(e) computational burden-UPMS belongs to the class of NP-hard problems, which is a computationally challenging domain that requires the utilization of advanced algorithms to obtain near-optimal solutions.

The subject disclosure describes, among other things, illustrative embodiments of dynamic UPMS with weighted jobs and balanced loads. In exemplary embodiments, a UPMS method/system may approach UPMS problems in two main phases or as two contributions or (e.g., separate) computational components. The first phase or component may be implemented as a core model or framework that facilitates initial scheduling, where jobs are optimally (or approximately optimally) allocated to workers that have different skill levels or capabilities and thus operate at varying speeds, and where worker loads are balanced (or approximately balanced). An objective may be to reduce or minimize the total expected completion time while maintaining a balanced load. The second phase or component may be implemented as a core model or framework with disruption-handling functionality, where the schedule is adapted (e.g., in real-time or near real-time) when disruption(s) occur. An objective may be to reduce or minimize the total expected completion time while reducing or minimizing the disruption impact.

It has been proven that the scheduling of n jobs among two identical machines with the objective of minimizing the total weighted completion time is NP-Hard. The problem of scheduling n jobs among m unrelated machines is therefore NP-hard in the strong sense. Dealing with NP-hard problems demands sacrificing one of three desires-solving the problem to optimality, solving the problem in polynomial time, and solving arbitrary instances of the problem. Exemplary embodiments provide for a framework that can be solved (at least approximately optimally) for various instances with different sizes and complexities in a reasonable (polynomial!) time. In various embodiments, a reasonable (polynomial!) time may be a runtime that scales polynomially with the size of the input. In certain embodiments, a reasonable (polynomial!) time may be defined depending on the context of the use case. For instance, if the tasks are completed within minutes, the algorithm that schedules and repairs the schedules should converge within minutes. Generally, the convergence time should be shorter than the smallest task's completion time; otherwise, the algorithm would add unnecessary time to overall task completion.

In one or more embodiments, a metaheuristics algorithm—i.e., a GA—may be used to determine near-optimal solutions for the initial scheduling and scheduling repair problems. The algorithm may conduct guided global searches, handle complex constraints efficiently, and allow for trade-off penalties associated with unbalanced loads and schedules that deviate from base schedules. To prevent the algorithm from becoming trapped in local optima, numerous jump operations may be implemented to guide the search. Further, to accelerate the search, a self-learning mechanism may be employed to allow the algorithm to learn effective (e.g., the most effective) jumps internally. This is helpful when the number of jobs increases in an environment where manual interventions are difficult or not possible.

Exemplary embodiments described herein address the dynamic nature of UPMS problems, which generally demands scheduling policies and solutions that facilitate real-time adjustments as conditions evolve, such as the arrival of new jobs, machine failure, unexpected rework, and so on. The innovative framework advantageously incorporates a high degree of personalization by design, where workers in a team are presented with individual work lists (e.g., trades to settle or to perform fraud checks on, etc.) that are personalized to their specific skill set and availability, rather than being presented with a single “shared” team work list. It is believed that no current industry or research model provides practical solutions to the UPMS problem. Embodiments of the dynamic UPMS method/system (with a comprehensive, mathematical framework) described herein are thus, in our view, an industry and research first.

One or more aspects of the subject disclosure include a device, comprising a processing system including a processor, and a memory that stores executable instructions that, when executed by the processing system, facilitate performance of operations. The operations may include receiving information regarding a plurality of jobs. The operations may further include assigning the plurality of jobs to a plurality of workers in accordance with a base schedule, wherein the base schedule is derived by solving an initial scheduling model that is configured to facilitate job assignments based on worker availability, capabilities, skills, experience, or a combination thereof, while reducing or minimizing job completion time and maintaining a determined balanced load. The operations may further include detecting one or more disruptions or events after the assigning. The operations may further include causing the base schedule to be repaired based on the detecting, wherein the causing involves solving a scheduling repairing model that is configured to repair an existing schedule based on detected disruptions or events, while reducing or minimizing an impact of the detected disruptions or events on the existing schedule.

One or more aspects of the subject disclosure include a non-transitory machine-readable medium, comprising executable instructions that, when executed by a processing system including a processor, facilitate performance of operations. The operations may include assigning a plurality of jobs to a plurality of workers in accordance with a base schedule, wherein the base schedule is derived by solving an initial scheduling model that is configured to facilitate job assignments based on worker availability, capabilities, skills, experience, or a combination thereof, while reducing or minimizing job completion time and maintaining a determined balanced load. The operations may further include detecting one or more disruptions or events after the assigning. The operations may further include causing the base schedule to be repaired based on the detecting, wherein the causing involves solving a scheduling repairing model that is configured to repair an existing schedule based on detected disruptions or events, while reducing or minimizing an impact of the detected disruptions or events on the existing schedule.

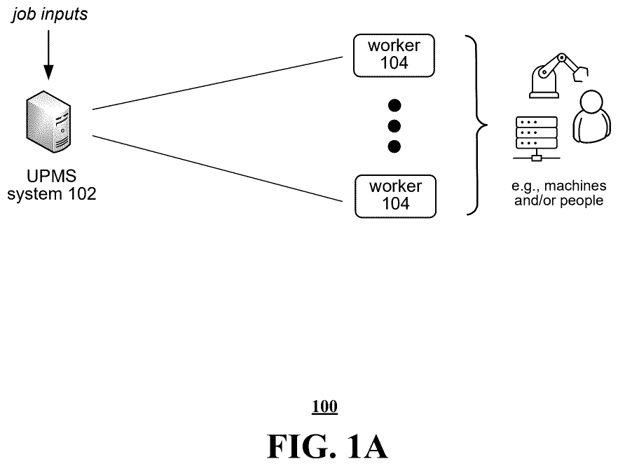

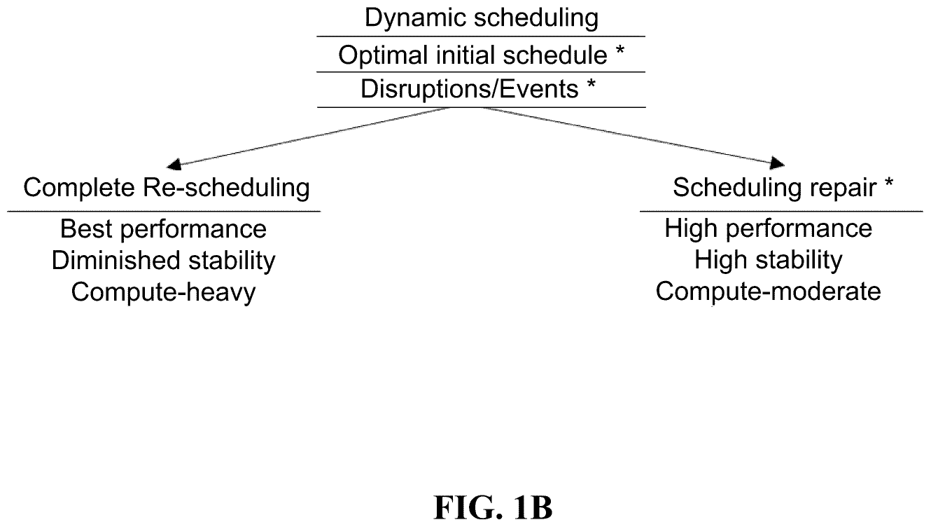

One or more aspects of the subject disclosure include a method. The method may include identifying, by a processing system including a processor, a plurality of jobs that are to be assigned. The method may further include solving, by the processing system, an initial scheduling model that is configured to facilitate job assignments based on worker availability, capabilities, skills, experience, or a combination thereof, while reducing or minimizing job completion time and maintaining a determined balanced load, resulting in a base schedule. The method may further include assigning, by the processing system, the plurality of jobs to a plurality of workers in accordance with the base schedule. The method may further include causing, by the processing system, the base schedule to be repaired based upon detection of one or more disruptions or events, resulting in a repaired schedule. The method may further include reassigning, by the processing system, some or all of the plurality of jobs to some or all of the plurality of workers based on the repaired schedule. FIG. 1A is a block diagram 100 of an example, non-limiting embodiment of UPMS in accordance with various aspects described herein. As shown in FIG. 1A, a UPMS system 102 may receive jobs or inputs regarding jobs, and may assign those jobs to one or more workers 104. Workers 104 may include individuals (or people) or machines, such as, for instance, computing devices, robots, drones/uncrewed aerial vehicles (UAVs), and/or other types of equipment. The term “worker” (or “workers”) may be used interchangeably with any of these possible entities. In one example implementation, individuals may be associated with respective computing devices to which the UPMS system 102 may be communicatively coupled for facilitating job assignments to those individuals. In one or more embodiments, workers 104 may be heterogeneous in that they may have different skills, capabilities, capacity, etc. and/or different levels of skills, capabilities, capacity, etc.

In various embodiments, the UPMS system 102 may be configured to provide dynamic UPMS with weighted jobs and balanced loads by way of an initial scheduling model and a scheduling repair model. In one or more embodiments, the initial scheduling model may be configured to schedule, assign, skill match, and balance the load, and the scheduling repair model may be configured to accept a schedule as a base schedule and attempt to address disruptions/events. For instance, the UPMS system 102 may reduce or minimize the expected total weighted completion time, where constraints may include assignment, skill matching, and load balancing, and where certain constraints on stability may ensure that no drastic changes are made to the initial schedule. Examples of disruptions/events may include the arrival of new jobs, the introduction of VIP jobs, management interventions, unavailability/addition of workers, and/or the like. In the UPMS context, the aforementioned weights may represent the “importance” of a task and, when an important task gets completed with tardiness, higher costs may be incurred. If the weights are assumed to be equal, the tasks are equally important. In the settlement scenario, the weights may be Central Securities Depositories Regulation (CSDR) penalty/penalties or a proxy for CSDR. CSDR penalty may be a form of penalty that is enforced on settlement failures to incentivize timely settlements.

Rather than creating a single worklist for multiple workers, the UPMS system 102 advantageously creates personalized work lists for individual workers, with worklist durations that are within certain bounds (e.g., no longer than three hours +/−15 minutes). In various embodiments, the UPMS system 102 may consider the weights of jobs (e.g., $-value, potential VIP client/failure probability, etc.), and may match jobs in a queue to individual workers based on their defined skill sets (e.g., speed, capabilities, knowledge, etc.), while keeping the distribution of the available workload among the available workers as equal as possible based on a load balancing tolerance level. FIG. 1B shows an example of a high-level dynamic scheduling scheme in accordance with various aspects described herein. As highlighted by way of asterisks (*), the dynamic scheduling may involve (e.g., optimal or approximately optimal) initial scheduling, where disruptions/events may trigger scheduling repair in a way that yields high performance and high stability while keeping computations at a moderate level.

In one or more embodiments, the UPMS system 102 may operate based on certain assumptions. For instance, it may be assumed that a given worker 104 can work on only one job or task at a time. As some other examples, preemption (i.e., interruption of the execution of a currently running task to allow for the execution of another one with a higher priority) and/or precedence (i.e., ordering in which tasks must be executed) may or may not be considered.

In one or more embodiments, the initial scheduling model and/or the scheduling repair model may incorporate some or all of the following parameters/functionalities (as well as additional ones, such as those relating to load anomaly, job failure probability, etc.):
m number of machines
n number of jobs
k position of a job in a sequence
i index of machines
j index of jobs
S index of skill group (1, . . . , S)

$${x}_{ij}^{k}$$

1 if job j is the kₜₕ job processed on machine i and 0 otherwise.

$${w}_{j}^{a}$$

accrued penalty (total value) of job j retrospectively

$${w}_{j}^{p}$$

predicted penalty (total value) of job j in future (if considered)
pᵢⱼ processing time of job j on machine i

$${C}_{ij}^{k}$$

completion time of job j scheduled kth on machine i

$${C}_{i}^{total}$$

completion time of the last job scheduled on machine i
Ωs subset of jobs that require certain skills
ΞΩs subset of jobs with skill set s
α load balancing tolerance level
M big penalty

Example mathematical notations that formulate the initial scheduling model are shown below, which identify an objective of reducing or minimizing job completion time, constraints or conditions (s.t.), and relationships/conditions for decision variables in the model. A GA (discussed in more detail below) may be validated and initial seeding may be performed based on parameters.

$$min {\sum }_{s = 1}^{S} {\sum }_{i = 1}^{\vert Ξ \vert} {\sum }_{k = 1}^{\vert Ω \vert} {\sum }_{{Ω}_{s}}^{Ω} {\sum }_{j ∈ {Ω}_{s}}^{\vert {Ω}_{s} \vert} [ {w}_{j}^{a} + E [ {w}_{j}^{p} ] ] ( {C}_{ij ∈ {Ω}_{s}}^{k} ) \qquad ( 1 )$$

$$s . t . {{\sum }_{k = 1}}^{\vert Ω \vert} {\sum }_{i ∈ {Ξ}_{{Ω}_{s}}}^{\vert {Ξ}_{{Ω}_{s}} \vert} {x}_{ij ∈ {Ω}_{s}}^{k} = 1 ∀ j ∈ {Ω}_{s} , ∀ s \qquad ( 2 )$$

$${\sum }_{s = 1}^{s} {\sum }_{j ∈ {Ω}_{s}}^{\vert {Ω}_{s} \vert} {x}_{ij ∈ {Ω}_{s}}^{k} \leq 1 ∀ i ∈ Ξ , ∀ k \qquad ( 3 )$$

$${C}_{ij ∈ {Ω}_{s}}^{k} = {\sum }_{l = 1}^{k} {\sum }_{s = 1}^{S} {\sum }_{j ∈ {Ω}_{s}}^{\vert {Ω}_{s} \vert} {p}_{ij} {x}_{ij ∈ {Ω}_{s}}^{l} ∀ i ∈ Ξ , ∀ k , ∀ s \qquad ( 4 )$$

$${C}_{i}^{total} = {\sum }_{s = 1}^{s} {\sum }_{j ∈ {Ω}_{s}}^{\vert {Ω}_{s} \vert} {C}_{ij}^{n} ∀ i ∈ Ξ \qquad ( 5 )$$

$$\frac{1}{\vert n \vert} ( 1 - α ) {\sum }_{i = 1}^{n} {C}_{i}^{total} \leq {C}_{i}^{total} \leq \frac{1}{\vert n \vert} ( 1 + α ) {\sum }_{i = 1}^{n} {C}_{i}^{total} ∀ i \qquad ( 6 )$$

$${x}_{ij ∈ {Ω}_{s}}^{k} ∈ \{ 0 , 1 \} ∀ j ∈ {Ω}_{s} , ∀ k , ∀ i ∈ Ξ , ∀ s \qquad ( 7 )$$

$$Ω = \{ {Ω}_{1} ⋃ {Ω}_{2} ⋃ {Ω}_{3} ⋃ … ⋃ {Ω}_{s} \} = \{ 1 , … , n \} \qquad ( 8 )$$

$$\{ {Ω}_{1} ⋂ {Ω}_{2} ⋂ {Ω}_{3} ⋂ … ⋂ {Ω}_{s} \} = \{ \} \qquad ( 9 )$$

$$Ξ = \{ {Ξ}_{{Ω}_{1}} ⋃ {Ξ}_{{Ω}_{2}} ⋃ {Ξ}_{{Ω}_{3}} ⋃ … {Ξ}_{{Ω}_{s}} \} = \{ 1 , … , m \} \qquad ( 10 )$$

$$\{ {Ξ}_{{Ω}_{1}} ⋂ {Ξ}_{{Ω}_{2}} ⋂ {Ξ}_{{Ω}_{3}} ⋂ … {Ξ}_{{Ω}_{s}} \} ⊆ \{ 1 , … , m \} \qquad ( 11 )$$

$$0 \leq α \leq 1 , \qquad ( 12 )$$

The objective in (1) minimizes the expected total weighted completion time.
Constraints in (2) ensure that jobs are assigned only once.
Constraints in (3) ensure that only one job is assigned to each machine at each position.
Constraints in (4) and (5) compute completion times for each job and machine loads.
Constraints in (6) ensure that machines loads are balanced.
Constraints in (7) show that xujen, are binary variables.
Constraints in (8) show that the jobs demand certain skills and their union equals all jobs. That is, there are no jobs that do not need skills.
Constraints in (9) show that the jobs demand only one type of skill.
Constraints in (10) show that the machines have certain skills and their union equals all machines. That is, there are no machines that do not have skills.
Constraints in (11) show that machines may have different types of skills.
Constraints in (12) show that the balance parameter is between [0, 1].

In exemplary embodiments, the UPMS system 102 may employ a GA to help solve the initial scheduling model. A GA is a type of optimization method that is able to efficiently search large solution spaces, such as a machine scheduling space, to find near-optimal solutions. In various embodiments, the GA may include the following components:
Chromosome creation: Converts the search space into chromosomes
   Assumed to be a nested list [[i, j], . . . ], where i: machine index and j: job index
Initialization seed: Determines the starting seed for chromosome to create the population (or pop)

Random assignment of jobs to machines/custom head start
Fitness function: Computes the objective function value for each chromosome
   Computes expected total completion time of all jobs along with a penalty for violating the load balancing at each chromosome.
      The fitness function may have a penalty term for deviating from the base solution at scheduling repair stage
Crossover operation: Pairs of parents are combined to create offspring
   Single point crossover may be adopted to help produce the next generation (or gen)
Mutation operation: Mutation operation with jump strategies and self-learning mechanism
   Adds diversity to the search to avoid getting trapped at local optima.
      This can be important when using custom head starts.
Selection: Tournament selection chooses individuals with best fitness values for the next population generation
Termination: Population generation continues until either a maximum breakout iteration or a maximum generation is met

As part of algorithm development, a brute force method was used to ensure that the GA converges to the optimal (or opt) solution-see table below for example results.

| | | | GA | | | n- | Weng's |
|---|---|---|---|---|---|---|---|
| | n- | n- | against | | | tour- | heuristic |
| No. | jobs | machines | opt | n-gen | n-pop | nament | against opt |
| 1 | 10 | 2 | 0.00% | ~50 | ~50 | 4 | 1.17% |
| 2 | 10 | 3 | 0.00% | ~100 | ~50 | 4 | 0.00% |
| 3 | 10 | 4 | 0.00% | ~100 | ~50 | 4 | 0.36% |
| 4 | 10 | 5 | 0.00% | ~100 | ~50 | 4 | 0.01% |
| 5 | 10 | 6 | 0.16% | ~100 | ~50 | 4 | 3.01% |
| 6 | 10 | 7 | 0.86% | ~100 | ~50 | 4 | 4.20% |
| 7 | 10 | 8 | 0.43% | ~100 | ~50 | 4 | 5.21% |
| 8 | 10 | 9 | 1.36% | ~100 | ~50 | 4 | 5.82% |
| 9 | 10 | 10 | 0.27% | ~100 | ~50 | 4 | 3.32% |

The solution was compared against heuristics discussed in Weng et al., “Unrelated parallel machine scheduling with setup consideration and a total weighted completion time objective,” International journal of production economics 70.3 (2001): 215-226 (hereafter “Weng”), incorporated by reference herein in its entirety. The comparison is discussed in more detail below. The brute force method solved the problem of x₁+x₂+x₃+ . . . +xₘ=n, which has

$$( \begin{matrix}n + m - 1 \\ m - 1\end{matrix} )$$

possible solutions.

When experiments with large size (500+) queues were conducted, it was observed that the initial seed can significantly impact the convergence time. It was also observed that, for such large queues and where a random start (or a random seed) was used to randomly assign jobs to machines at the outset, the optimal solution was never reached or neared. Thus, in some embodiments, a fast custom head start (or custom seed) may be employed in the algorithm. The custom head start may involve sorting the jobs in an ascending order based on job execution time and/or job weight, and allocating the sorted jobs one at a time to the machines with the lowest load. In one or more embodiments, the custom method may be the same as or similar to that described in Liu et al. “Online scheduling on m uniform machines to minimize total (weighted) completion time,” Theoretical computer science 410.38-40 (2009) 3875-3881, which is incorporated by reference herein in its entirety.

In exemplary embodiments, various of the GA parameters may be adaptable based on search progress. That is, the values of these parameters may increase or decrease based on the progress of the algorithm. Such parameters include:
Population size: which determines the number of chromosome generated at each generation;
Tournament size: which adjusts the exploration and exploitation, and determines the size of the individuals selected for the next population generation (where a smaller tournament size may favor exploitation by prioritizing selection of the best individuals, which can lead to faster convergence, but may miss out on exploring other potential solutions; and where a larger tournament size may favor exploration by increasing the chance of selecting diverse individuals);
Mutation rate: which is the rate at which mutation is allowed to occur;
Crossover rate: which is the rate at which crossover is allowed to occur; and
Self-learning patience: which allows for jumps to be added/dropped from the jump operations distribution (discussed below).

It is to be understood and appreciated that population size is an important parameter as it significantly impacts the compute load. An objective may be to reduce the population size using different techniques so as to reduce the compute burden while simultaneously not adversely impacting the convergence.

Because the custom start usually offers good solutions, it is likely that the GA can become trapped—e.g., in local optima. Thus, in exemplary embodiments, the algorithm may include a mutation scheme that involves jump operations. The jump operations may facilitate the search and prevent the algorithm from becoming trapped in local optima, thus providing for a good head start. Example jump operations include:
1. Swapping two consecutive jobs in one machine
2. Selecting three consecutive jobs and swapping job 1 and job 3 in one machine
3. Selecting three consecutive jobs and swapping job 1 and job 2 in one machine
4. Selecting three consecutive jobs and swapping job 2 and job 3 in one machine
5. Swapping two non-consecutive jobs in one machine
6. Swapping the machines between same jobs
7. Swapping jobs between two machines from the same spot in the sequence
8. Swapping jobs between two machines in n and n+1 spots in the sequence
9. Swapping jobs between two machines at two random spots in the sequence
10. Swapping jobs between two randomly selected assignments
11. Swapping machines between two randomly selected assignment
12. Assigning a random machine to an assignment
13. Assigning a random job to machine

In exemplary embodiments, the GA may include a self-learning mechanism (e.g., that facilitates self-learning similar to that provided by reinforcement learning), where actions (i.e., jumps) that improve the rewards (i.e., reduces or minimizes cost) are reinforced. The self-learning mechanism may be associated with a fixed self-learning patience value, and may be implemented as follows. Initially, all jumps may be sampled via a uniform distribution. If a jump is successful, the frequency of that jump in the mix increases by one. If a jump is unsuccessful (i.e., if it deteriorates the current solution), the algorithm may check whether the self-learning counter has exceeded the self-learning patience value (e.g., 3 times or any other value). If the self-learning counter has exceeded the self-learning patient value, then the jump frequency may be reduced by one; otherwise no change to the jump frequency may be made. If the selected jumps continue to deteriorate the current solution for more than the self-learning patience value plus some fixed tolerance value, then the search may break out (i.e., the breakout number of iterations), and the current solution may be provided as the best solution found. If the search becomes trapped in local optima, the probability of the most common jump decreases by one in order to allow the other jumps to be selected, which diversifies the search to escape the local optima. Being trapped in local optima may be detected based on a user defined tolerance (e.g., when the best current solution does not change after a certain number of iterations). In such a case, the algorithm may detect the issue and cause the search to adaptively switch the parameters. If the search continues to be trapped, the jumps may be mashed up (or reset to uniform) as the last resort. This process may be evidence-based (empirical), meaning that if there is no improvement after a threshold number of iterations, then the search may break out (i.e., the breakout number of iterations) and the current solution may be provided as the best solution found.

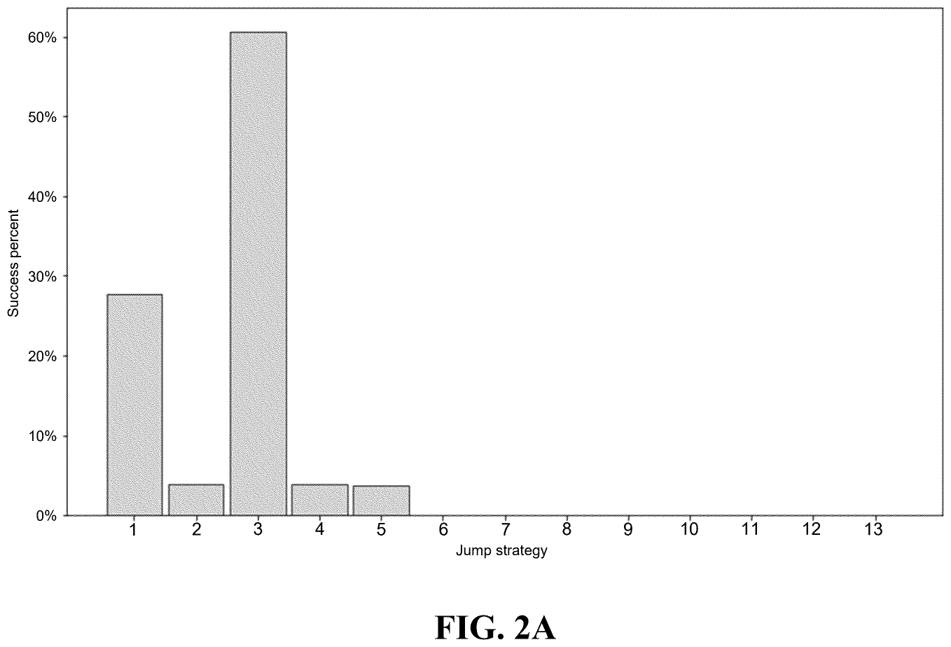

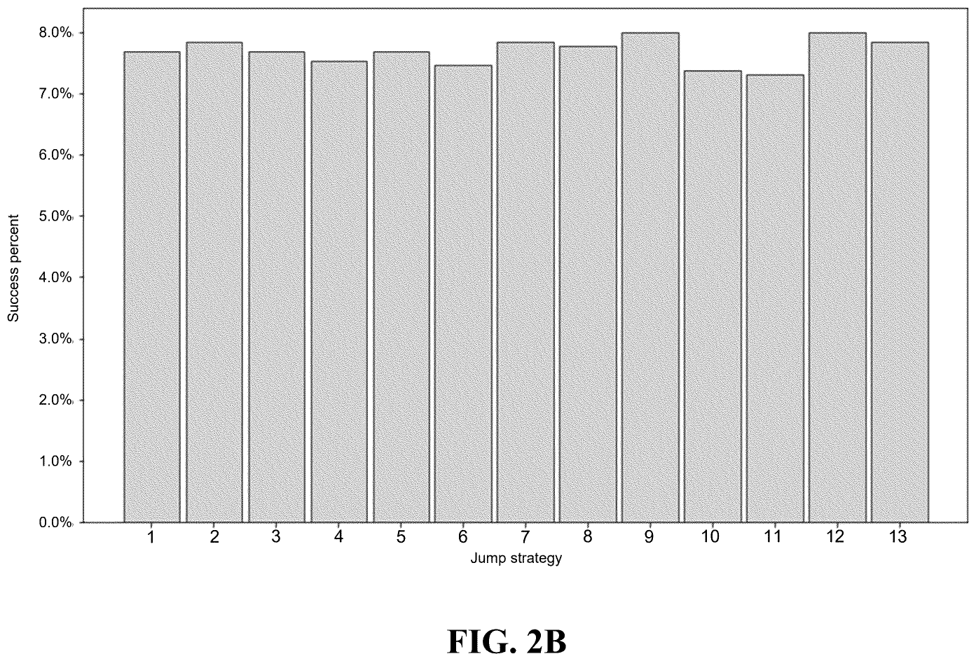

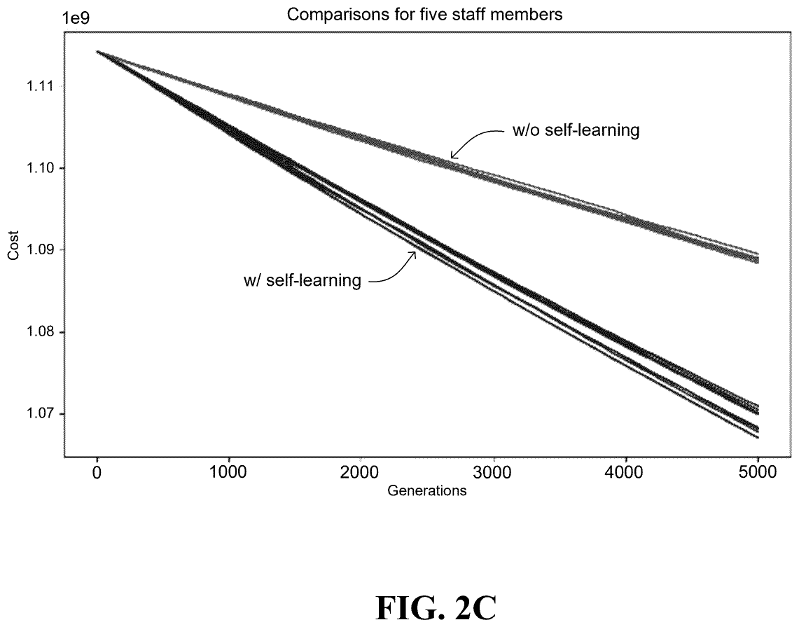

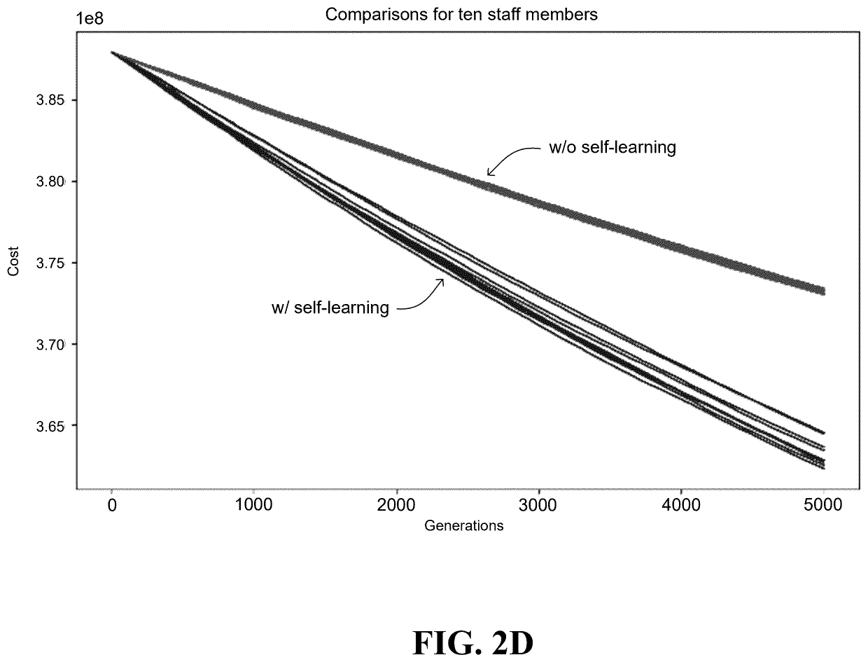

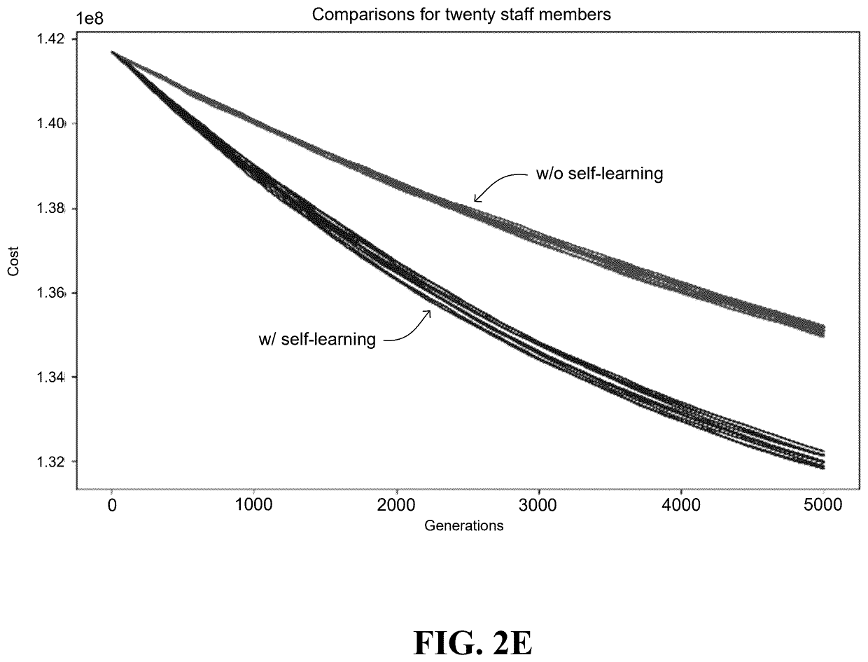

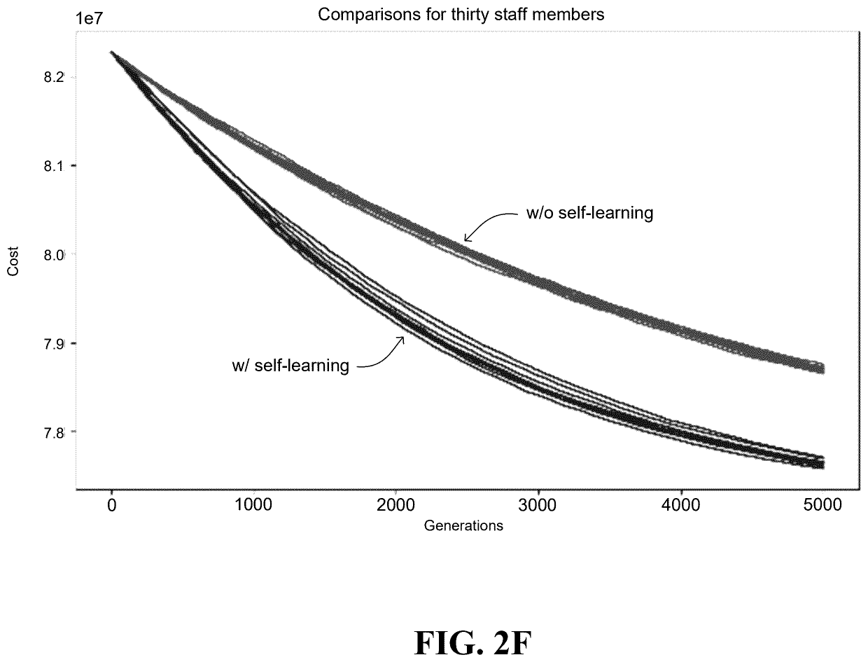

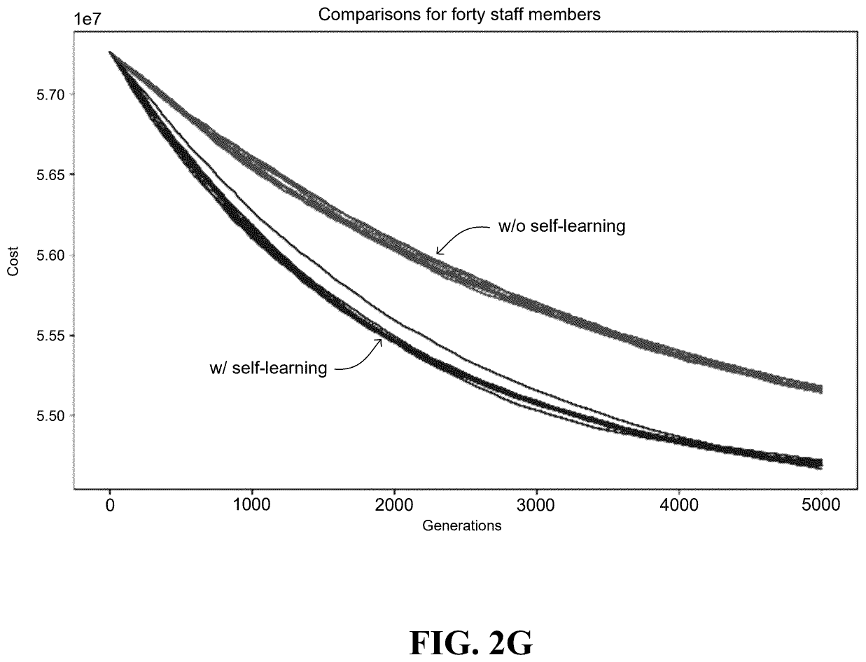

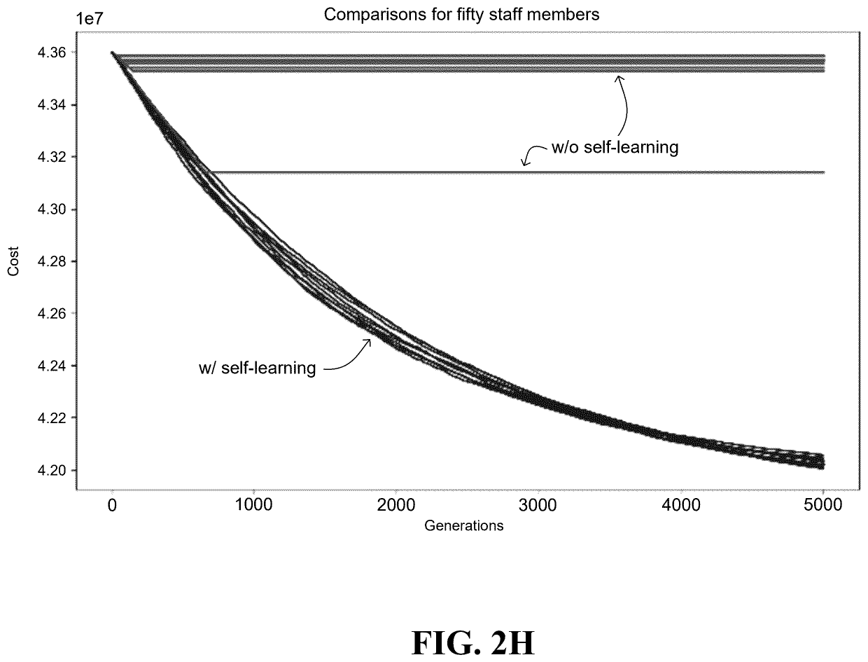

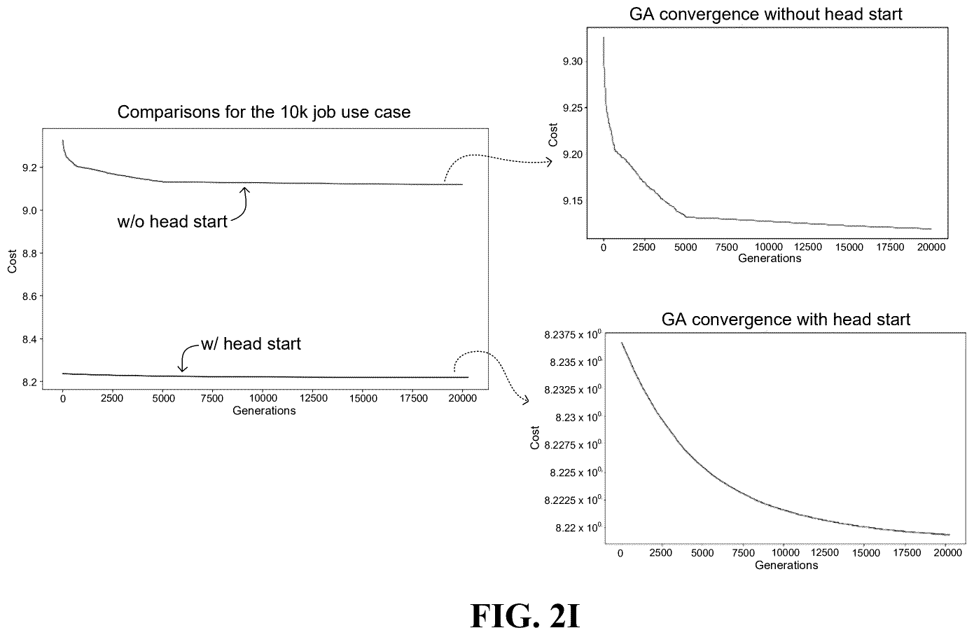

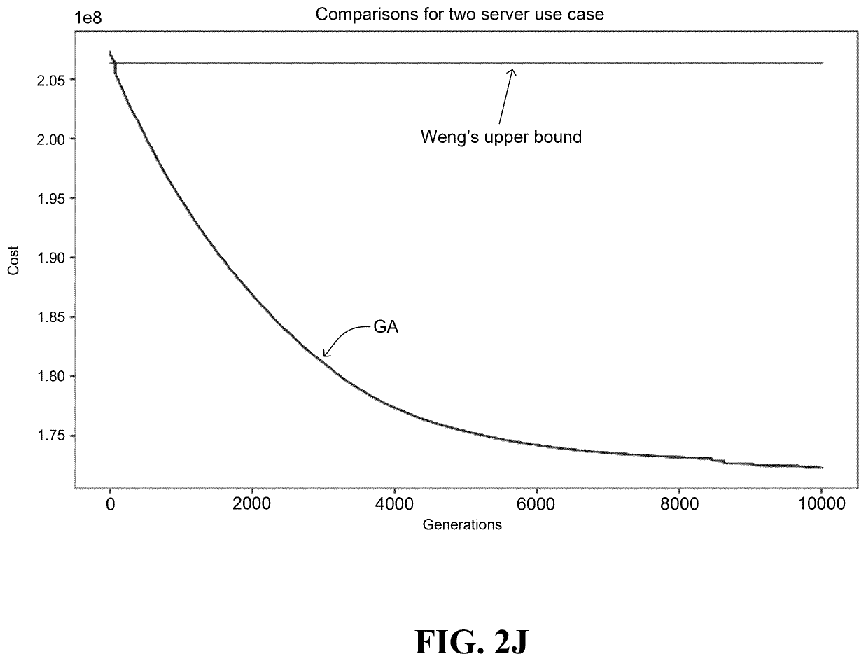

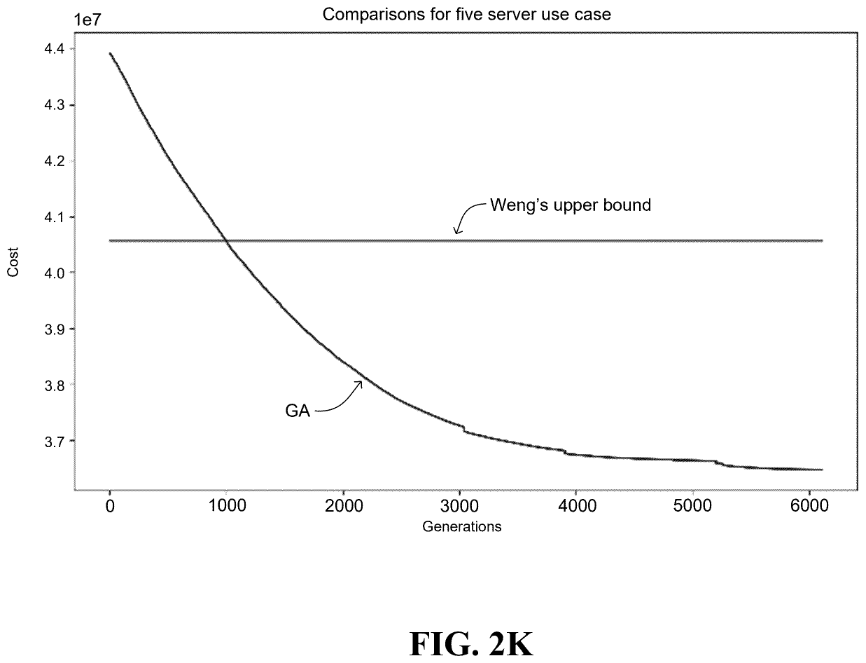

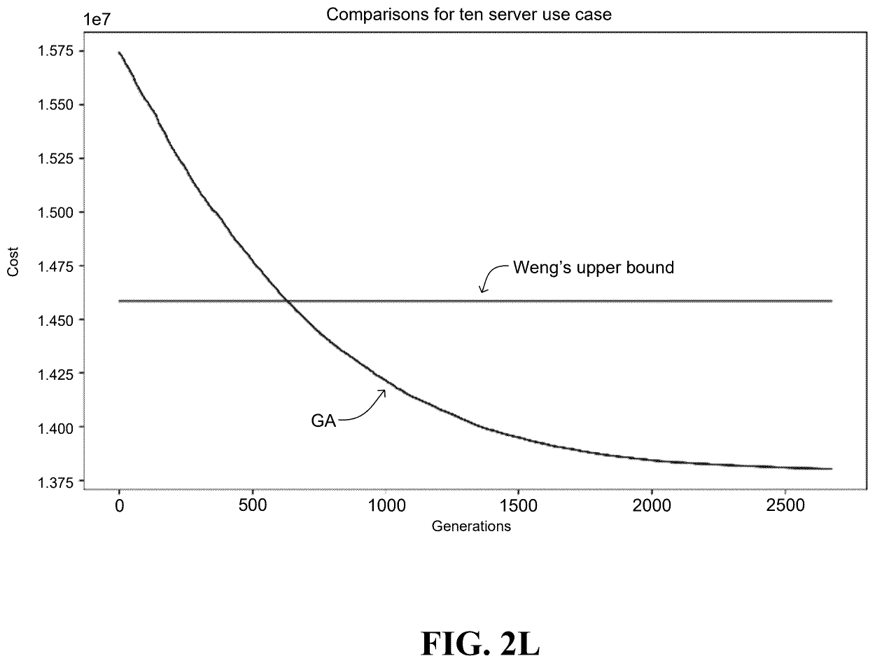

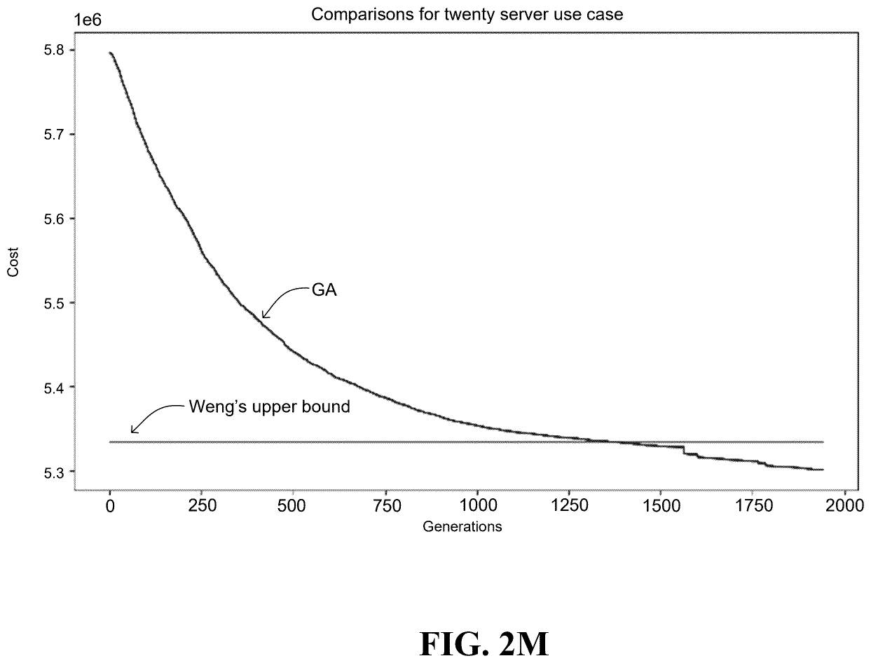

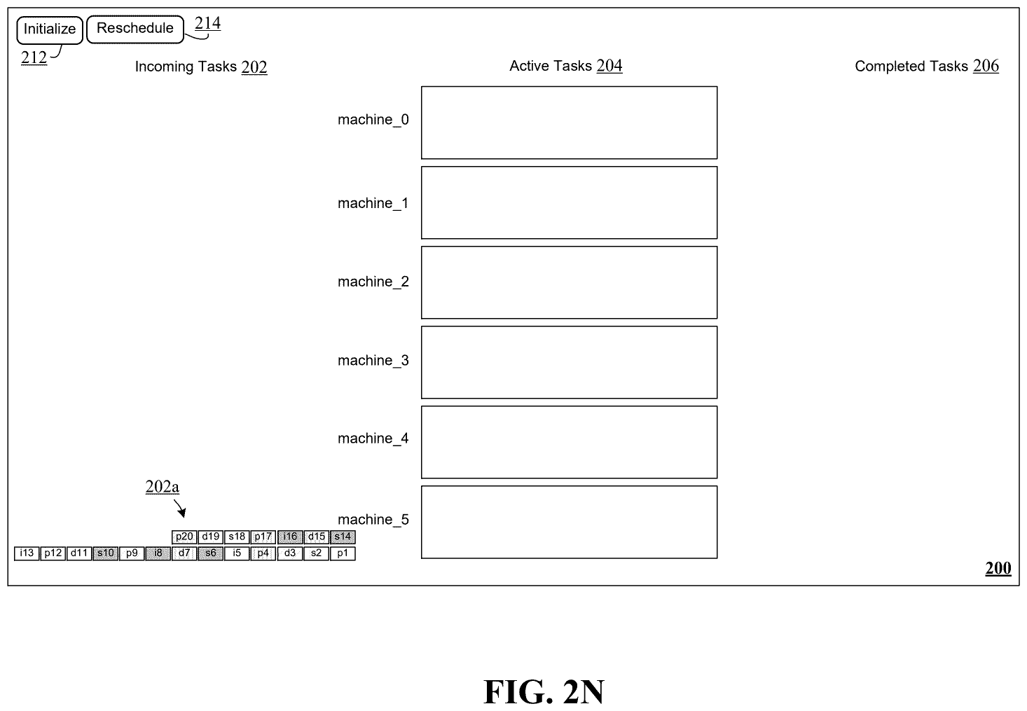

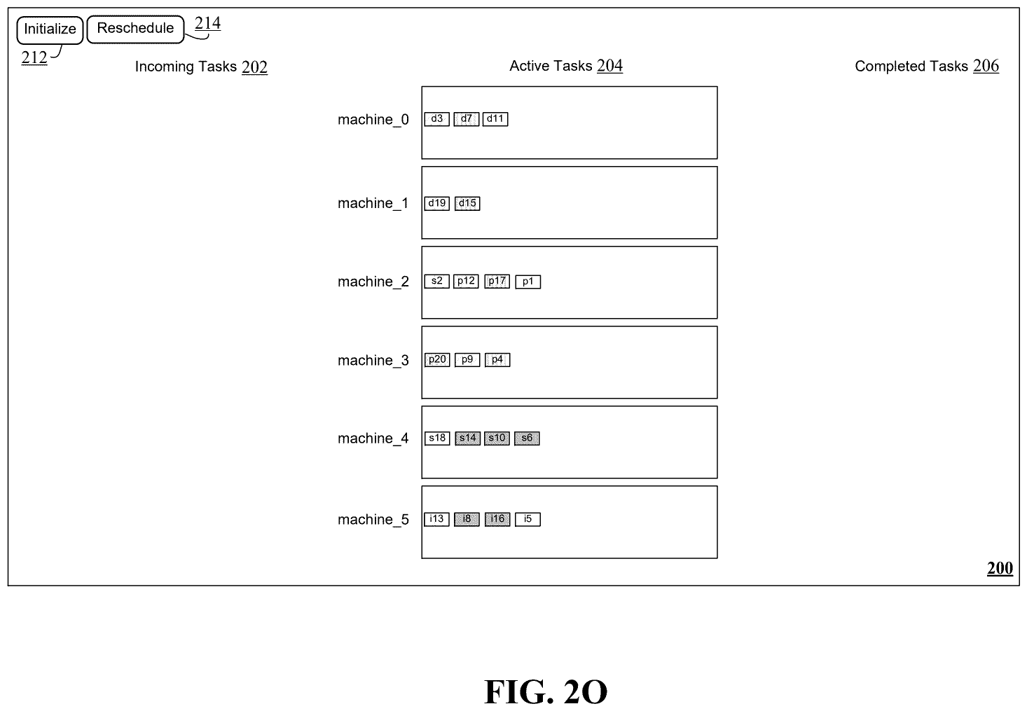

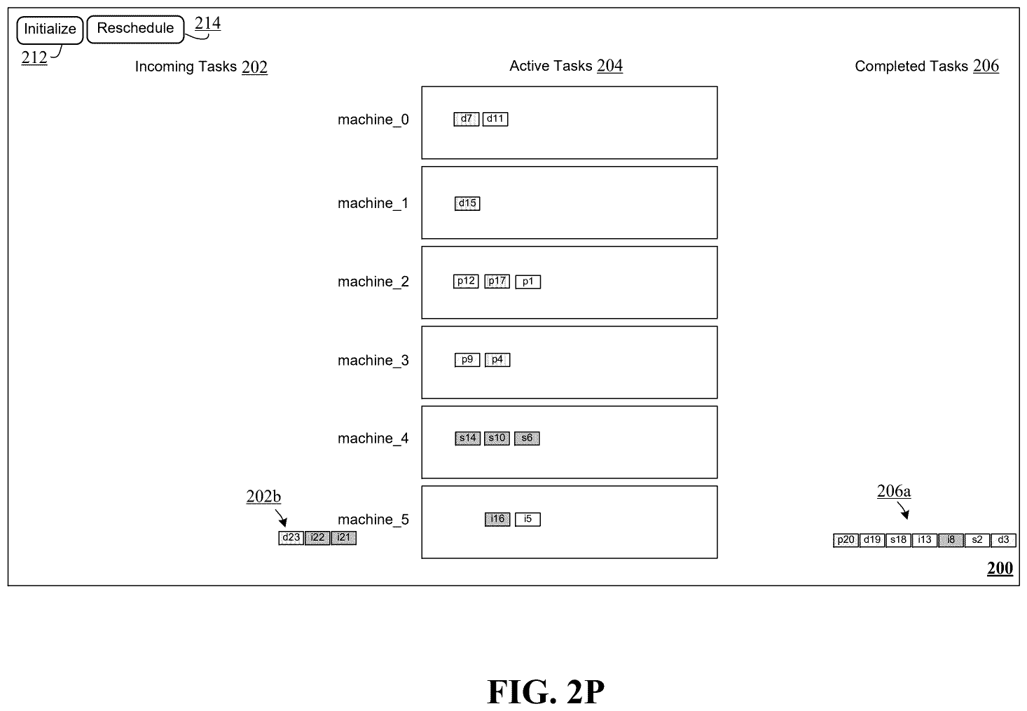

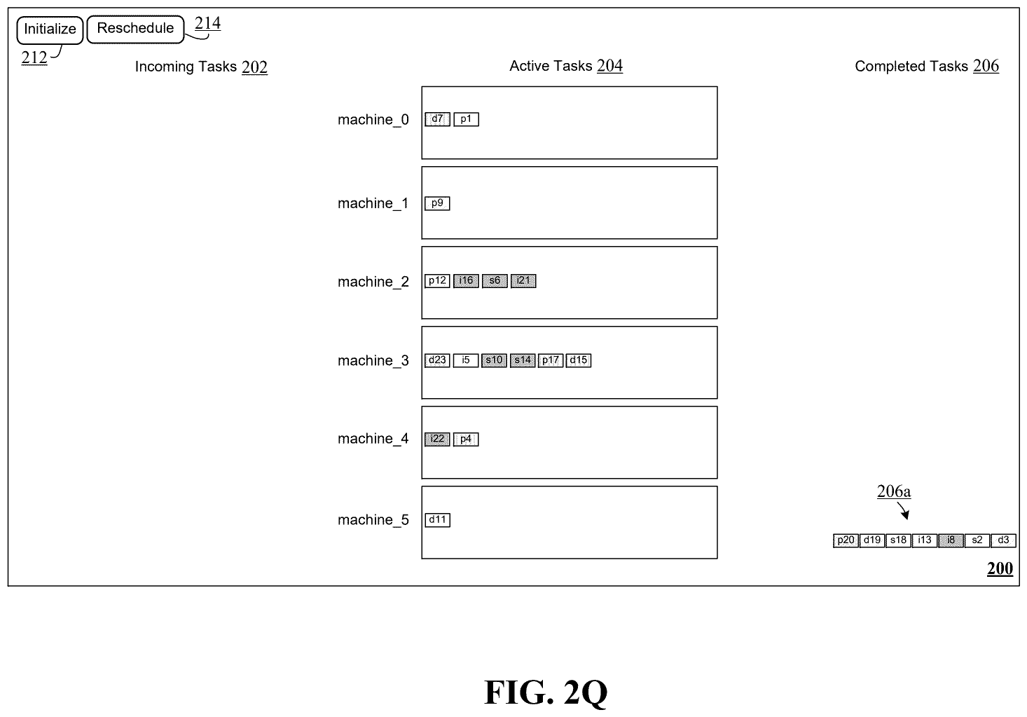

FIG. 2A shows an example jump selection distribution when the self-learning mechanism is implemented, in accordance with various aspects described herein. Specifically, FIG. 2A shows the distribution when certain jumps are reinforced. Here, jump #3 can be seen as yielding promising results and thus the algorithm may be encouraged to sample from it more often. FIG. 2B shows jump samples taken from a uniform distribution of jumps where self-learning is not implemented. For self-learning to be effective, the generation number may be relatively high (e.g., 100+). For small population sizes (e.g., [10-15] range for 10,000 (10 k) jobs), the larger number of generations does not add extra load on compute; based on experimentation, we observed that the generation size is less demanding than the population size.

Among the unscheduled jobs, Weng's heuristic algorithm assigns the job with the smallest ratio of processing time plus setup time to weight. That is to say, assign job j on machine k, where job j and machine k are chosen such that min {[tᵢ+(Pᵢⱼ)]/wⱼ} where i=1, 2, . . . m, and j=1, . . . , n. However, Weng lacks constraints with respect to balancing the load. Further, two drawbacks were observed when using the Weng's heuristics. First, the compute demand increases when the size of the queue increases significantly. Also, unreliable solutions were obtained—for instance, in two of our edge cases, Weng's heuristics gave+co as a minimum cost. In exemplary embodiments of the UPMS system 102, the load balancing constraint may be imposed as a penalty. In particular,

$$\frac{1}{\vert n \vert} ( 1 + α ) {\sum }_{i = 1}^{m} {C}_{i}^{total} and \frac{1}{\vert n \vert} ( 1 - α ) {\sum }_{i = 1}^{m} {C}_{i}^{total}$$

may be computed, and jobs may be arbitrarily assigned to any machine that is between the two computed bounds.

In an example experiment, the GA was run ten times with and without the self-learning mechanism for a queue of 10k jobs with the following configuration:
population size: 16 (adaptive)
tournament size: 8 (adaptive)
max generations: 5000 (fixed)
breakout iteration: 15 (fixed)
mutation rate: 0.01 (adaptive)
crossover: 1 (adaptive)
self-learning patience rate: 3 (fixed)

FIGS. 2C-2H show cost comparisons (for five workers, ten workers, twenty workers, thirty workers, forty workers, and fifty workers, respectively) in cases where self-learning is employed versus where self-learning is not employed. In each of the graphs shown, the X-axis represents the number of generations and the Y-axis represents costs, where the objective is to have lower cost (e.g., lower monetary cost in this example). As an example, this may be a proxy for the penalty that a financial firm may incur for late settlements. It will be understood and appreciated that cost may refer to monetary cost and/or time cost depending on the application. In some cases, monetary cost may scale with time. In various use cases/domains, cost may be purely time-based. As can be seen from FIGS. 2C-2H, the smaller the number of workers, the costlier the process (i.e., it costs more to finish the jobs). As can also be seen, self-learning (at least in this particular example) allows for faster convergence in all instances regardless of the number of workers.

FIG. 2I shows a cost comparison in a case where a custom head start (w/head start) is employed versus where a random start (w/o a head start) is employed. Here, the X-axis also represents the number of generations and the Y-axis also represents cost (e.g., monetary cost in this example). One skilled in the art would readily recognize the cost benefits provided by the self-learning mechanism and the custom head start. Further, FIGS. 2J-2M show cost comparisons (for the two worker scenario, five worker scenario, ten worker scenario, and twenty worker scenario, respectively) that illustrate the lower cost (particularly as the number of generations increases) provided by the GA relative to Weng's upper bound. As can be seen from these graphs, the GA easily outperforms Weng's solution in terms of cost, although it sometimes takes longer to pass its performance. Weng's solution serves as a useful upper bound (i.e., sanity check) for assessing the quality of the GA's solution.

In one or more embodiments, the scheduling repair model may allow new jobs to be stacked on top of existing jobs. Responsive to a detected disruption event, the scheduling repair model may search for a new (e.g., optimal or approximately optimal) solution that minimally deviates from an input base schedule (e.g., does not deviate from the base schedule by more than a threshold amount). In various embodiments, the threshold amount may depend on the specific context of the use case and what is desirable for users. For instance, limiting the number of jobs that are reassigned from one machine to another may be defined as the deviation. If the number of reassignments exceeds “L”, then the model may penalize the objective by “M” to control/restrain the reassignments. Now if “L=0” is assumed, it means that no reassignments are allowed—that is, existing jobs may be reordered, where new incoming jobs may be added to the mix.

In various embodiments, repairing of a schedule by the scheduling repair model may be event-driven (i.e., based upon occurrence of a disruption/event), periodic (e.g., performed once every 5 minutes regardless of the occurrence of a disruption/event), or done in a hybrid manner (both periodically and based on disruptions/events). In one or more embodiments, repairing of a schedule by the scheduling repair model may be performed by way of local searching (i.e., where the search is limited as the GA is restricted from searching freely in the solution space so as to avoid disrupting the current job assignment too drastically), heuristics (i.e., a step-by-step bespoke non-GA method, such as Weng's method), or global searching (i.e., where the GA algorithm is allowed to search the whole solution space with no limits).

In certain embodiments, the scheduling repair model may include a fitness function (i.e., a translation of the objective function in the GA) in which deviations from a base schedule or solution (e.g., the current solution) are penalized. In one or more embodiments, deviation may be defined based on job assignments. In various embodiments, the GA may be configured to keep assigned jobs with the respective machine whenever feasible. It is possible that, when enforcing the deviation rule, high objective values may result. Imagine a case where a job needs a certain skill that only one machine possesses and that machine is fully loaded. In such a case, the model may reassign some jobs (i.e., unload some jobs) and absorb the penalty in order to yield a feasible allocation solution. In essence, the model may try its best to avoid such scenarios, but at times, reassignment may be forced due to limited resources/skill sets. Of course, if assigned jobs are kept with the same machine, the algorithm may be free to update the job sequence for that machine.

Example mathematical notations that formulate the scheduling repair model are shown below. With the exception of some additional constraints and added penalty in the objective function, generally the same GA may be used here for repair.

$${ψ}_{ij}^{k}$$

deviations between current and base solution at position k of machine i for job j

$${X}_{ij ∈ {Ω}_{s}}^{k , base}$$

base solution obtained from the initial schedule
M deviation penalty

$$min {\sum }_{s = 1}^{S} {\sum }_{i = 1}^{\vert Ξ \vert} {\sum }_{k = 1}^{\vert Ω \vert} {\sum }_{{Ω}_{s}}^{Ω} {\sum }_{j ∈ {Ω}_{s}}^{\vert {Ω}_{s} \vert} [ {w}_{j}^{a} + E [ {w}_{j}^{p} ] ] ( {C}_{ij ∈ {Ω}_{s}}^{k} ) + {\sum }_{s = 1}^{S} {\sum }_{i = 1}^{\vert Ξ \vert} {\sum }_{{Ω}_{s}}^{Ω} {\sum }_{j ∈ {Ω}_{s}}^{\vert {Ω}_{s} \vert} M {ψ}_{ij}^{k} \qquad ( 1 )$$

$$s . t . {ψ}_{ij}^{k} = {\sum }_{k = 1}^{\vert Ω \vert} {\sum }_{i ∈ {Ξ}_{{Ω}_{s}}}^{\vert {Ξ}_{{Ω}_{s}} \vert} {x}_{ij ∈ {Ω}_{s}}^{k} - {\sum }_{k = 1}^{\vert Ω \vert} {\sum }_{i ∈ {Ξ}_{{Ω}_{s}}}^{\vert {Ξ}_{{Ω}_{s}} \vert} {X}_{ij ∈ {Ω}_{s}}^{k , base} ∀ j ∈ {Ω}_{s} , ∀ s \qquad ( 2 )$$

$${\sum }_{k = 1}^{\vert Ω \vert} {\sum }_{i ∈ {Ξ}_{{Ω}_{s}}}^{\vert {Ξ}_{{Ω}_{s}} \vert} {x}_{ij ∈ {Ω}_{s}}^{k} = 1 ∀ j ∈ {Ω}_{s} , ∀ s \qquad ( 3 )$$

$${\sum }_{s = 1}^{s} {\sum }_{j ∈ {Ω}_{s}}^{\vert {Ω}_{s} \vert} {x}_{ij ∈ {Ω}_{s}}^{k} \leq 1 ∀ i ∈ Ξ , ∀ k \qquad ( 4 )$$

$${C}_{ij ∈ {Ω}_{s}}^{k} = {\sum }_{l = 1}^{k} {\sum }_{s = 1}^{S} {\sum }_{j ∈ {Ω}_{s}}^{\vert {Ω}_{s} \vert} {p}_{ij} {x}_{ij ∈ {Ω}_{s}}^{l} ∀ i ∈ Ξ , ∀ k , ∀ s \qquad ( 5 )$$

$${c}_{i}^{total} = {\sum }_{s = 1}^{S} {\sum }_{j ∈ {Ω}_{s}}^{\vert {Ω}_{s} \vert} {C}_{ij}^{n} ∀ i ∈ Ξ \qquad ( 6 )$$

$$\frac{1}{\vert n \vert} ( 1 - α ) {\sum }_{i = 1}^{n} {C}_{i}^{total} \leq {C}_{i}^{total} \leq \frac{1}{\vert n \vert} ( 1 + α ) {\sum }_{i = 1}^{n} {C}_{i}^{total} ∀ i \qquad ( 7 )$$

$${x}_{ij ∈ {Ω}_{s}}^{k} ∈ \{ 0 , 1 \} ∀ j ∈ {Ω}_{s} , ∀ k , ∀ i ∈ Ξ , ∀ s \qquad ( 8 )$$

$$Ω = \{ {Ω}_{1} ⋃ {Ω}_{2} ⋃ {Ω}_{3} ⋃ … ⋃ {Ω}_{s} \} = \{ 1 , … , n \} \qquad ( 9 )$$

$$\{ {Ω}_{1} ⋂ {Ω}_{2} ⋂ {Ω}_{3} ⋂ … ⋂ {Ω}_{s} \} = \{ \} \qquad ( 10 )$$

$$Ξ = \{ {Ξ}_{{Ω}_{1}} ⋃ {Ξ}_{{Ω}_{2}} ⋃ {Ξ}_{{Ω}_{3}} ⋃ … {Ξ}_{{Ω}_{s}} \} = \{ 1 , … , m \} \qquad ( 11 )$$

$$\{ {Ξ}_{{Ω}_{1}} ⋂ {Ξ}_{{Ω}_{2}} ⋂ {Ξ}_{{Ω}_{3}} ⋂ … {Ξ}_{{Ω}_{s}} \} ⊆ \{ 1 , … , m \} \qquad ( 12 )$$

$$0 \leq α \leq 1 , \qquad ( 13 )$$

The objective in (1) minimizes the expected total weighted completion time that includes the penalty for deviation from the base solution.
Constraints in (2) compute the deviations.
Constraints in (3-13) are the same as constraints (2-12), respectively, of the initial scheduling model.

FIGS. 2N-2Q demonstrate an example flow of dynamic UPMS in accordance with various aspects described herein. In exemplary embodiments, a UPMS interface 200 may enable high-level user management of job assignment using the UPMS system 102. As depicted in FIG. 2N, the UPMS interface 200 may include an incoming tasks section 202 for displaying new jobs 202a that are to be assigned, an active tasks section 204 for displaying jobs that have been assigned to machines (here in this example, machines_0 through machines_5), and completed tasks section 206 for displaying jobs that have been completed by the machines. Referring to FIG. 20, the jobs 202a may be assigned to the machines_0 through machines_5 as shown. For instance, the UPMS system 102 may, similar to that described above, leverage a GA to solve an initial scheduling model so as to assign the jobs 202a to the machines_0 through machines_5. This may involve optimal or approximately optimal allocation of the jobs 202a to the machines_0 through machines_5 based on various criteria, such as, for instance, machine availability, machine capabilities (or skills/experience), etc., while reducing or minimizing completion time and maintaining a balanced or near balanced load among the machines_0 through machines_5. As shown in FIG. 2P, completed jobs 206a may no longer be presented in machines_0 through machines_5, but may instead be presented in the completed tasks section 206. Further, new incoming jobs 202b may be presented in the incoming tasks section 202. FIG. 2Q illustrates assignment of the new incoming jobs 202b, which may include reassignments of some of the earlier jobs 202a. For instance, the UPMS system 102 may, similar to that described above, leverage the GA to solve a scheduling repair model so as to assign the newly-arriving jobs 202b along with the previously-assigned jobs 202a among the machines_0 through machines_5. This may involve repairing the existing schedule or assignment of the jobs 202a while reducing or minimizing impact of the newly-arriving jobs 202b. In sum, embodiments of dynamic UPMS described herein provide for initial scheduling, scheduling repair based on disruptions/events, and updating of job queues.

As one example use case, the UPMS system 102 may be employed to facilitate job assignments for the settlements department at a financial firm or bank. In this case, the UPMS system 102 may be employed to facilitate (e.g., optimal or approximately optimal) assignment of jobs to settlements team members based on skill matching between jobs and members, while balancing distribution of the job load among the members, to achieve short (e.g., the shortest) completion time for all of the jobs. New jobs or events (e.g., member unavailability/breaks, etc.) may be accounted for by the UPMS system 102 via dynamic rescheduling. Use of the UPMS system 102 advantageously reduces or minimizes the spillage of recurring penalties that the department may otherwise incur. It is to be understood and appreciated that the UPMS system 102 can of course be employed in a variety of other use cases that involve job assignments to heterogeneous workers.

Exemplary embodiments are necessarily performed using computer technology. The UPMS system 100 advantageously provides for at least the practical application of dynamic UPMS where jobs are optimally or approximately optimally assigned to heterogeneous workers. The total expected job completion time is reduced or minimized while taking into account job weights and while maintaining a balanced load, where customized job lists are identified for the heterogeneous workers, and where the impact of disruptions/events on an initial schedule is reduced or minimized.

In various embodiments, other considerations may be taken into account in the algorithm implementation.

Size of job list and machines: When the size of the jobs list and available machines grow (10 k+jobs, 100+machines), parallelization of the GA may be implemented in addition to the custom start and self-learning mechanisms discussed above. Liu et al., “A scalable parallel genetic algorithm for the generalized assignment problem,” Parallel computing 46 (2015): 98-119 (which is incorporated by reference herein in its entirety) discusses a method of parallelizing a GA for combinatorial optimization problems, which can be leveraged/adapted for parallelization of the GA described herein. The benefits of parallelization certainly become apparent when the sizes exceed certain thresholds; otherwise, the computational overhead may outweigh the benefits. This, of course, will go hand in hand with the time that is tolerable for convergence in the use case context.

Artificial Intelligence (AI)/Model parameters considerations: Some of the scheduling parameters may be determined within the model and some outside of the model based on the use case context, user preference, and/or production deployment needs. For instance, in the settlement domain, the settlement staff might demand avoidance of re-scheduling “n” number of closest jobs to the worker (machine) during scheduling repair so as to mitigate any distraction that the rescheduling might cause (e.g., in the next 30 minutes of the workday). This parameter may be set in or outside of the model. Similarly for VIP jobs, they may be scheduled/pre-filtered outside of the model (e.g., pre-scheduled), which can keep the model parameters manageable; or, VIP jobs may be considered with a significant penalty within the model itself, allowing the model to schedule them alongside other jobs.

Objective function parameters: Some or all of the objective function parameters may be replaced with the appropriate parameters in the use case context. The weight parameter (w) represents the importance of a job for the scheduling. The weight in the context of settlement scheduling may be represented by a penalty (e.g., CSDR or any proxy for $ trade value) for not settling on time. In addition, the weight may be inflated or deflated based on the domain; for instance, it can be inflated for VIP jobs.

It is to be understood and appreciated that, although one or more of FIGS. 1A-2Q might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various components, devices, systems, etc. may have been illustrated in one or more of FIGS. 1A-2Q as separate components, devices, systems, etc., it will be appreciated that multiple components, devices, systems, etc. can be implemented as a single component, device, system, etc., or a single component, device, system, etc. can be implemented as multiple components, devices, systems, etc. Additionally, functions described as being performed by one component, device, system, etc. may be performed by multiple components, devices, systems, etc., or functions described as being performed by multiple components, devices, systems, etc. may be performed by a single component, device, system, etc.

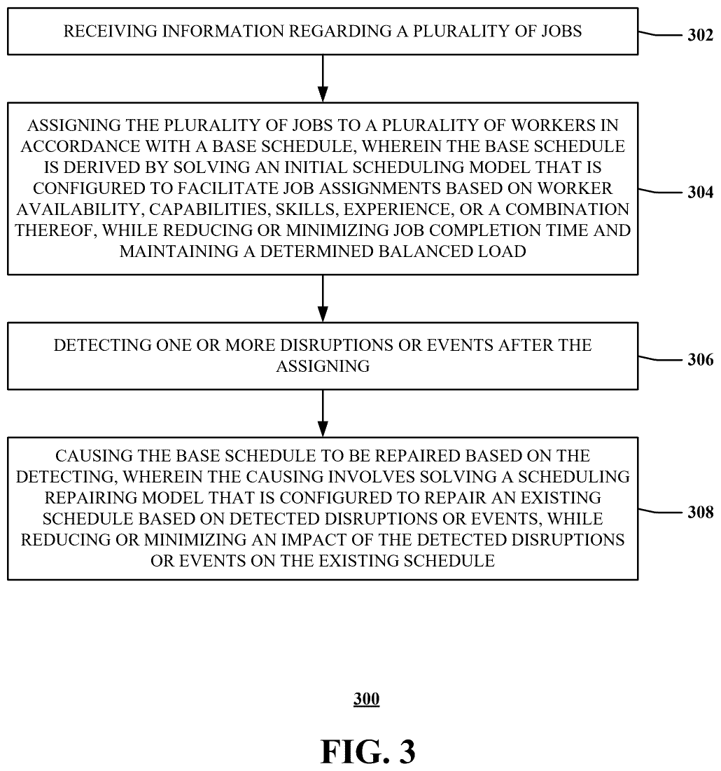

FIG. 3 depicts an illustrative embodiment of a method 300 in accordance with various aspects described herein.

At 302, the method can include receiving information regarding a plurality of jobs. For example, the UPMS system 102 may, similar to that described above with respect to one or more of FIGS. 1A, 1B, 2A, 2N, 20, 2P, and 2Q perform one or more operations that include receiving information regarding a plurality of jobs.

At 304, the method can include assigning the plurality of jobs to a plurality of workers in accordance with a base schedule, wherein the base schedule is derived by solving an initial scheduling model that is configured to facilitate job assignments based on worker availability, capabilities, skills, experience, or a combination thereof, while reducing or minimizing job completion time and maintaining a determined balanced load. For example, the UPMS system 102 may, similar to that described above with respect to one or more of FIGS. 1A, 1B, 2A, 2N, 20, 2P, and 2Q perform one or more operations that include assigning the plurality of jobs to a plurality of workers in accordance with a base schedule, wherein the base schedule is derived by solving an initial scheduling model that is configured to facilitate job assignments based on worker availability, capabilities, skills, experience, or a combination thereof, while reducing or minimizing job completion time and maintaining a determined balanced load.

At 306, the method can include detecting one or more disruptions or events after the assigning. For example, the UPMS system 102 may, similar to that described above with respect to one or more of FIGS. 1A, 1B, 2A, 2N, 20, 2P, and 2Q perform one or more operations that include detecting one or more disruptions or events after the assigning.

At 308, the method can include causing the base schedule to be repaired based on the detecting, wherein the causing involves solving a scheduling repairing model that is configured to repair an existing schedule based on detected disruptions or events, while reducing or minimizing an impact of the detected disruptions or events on the existing schedule. For example, the UPMS system 102 may, similar to that described above with respect to one or more of FIGS. 1A, 1B, 2A, 2N, 20, 2P, and 2Q perform one or more operations that include causing the base schedule to be repaired based on the detecting, wherein the causing involves solving a scheduling repairing model that is configured to repair an existing schedule based on detected disruptions or events, while reducing or minimizing an impact of the detected disruptions or events on the existing schedule.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

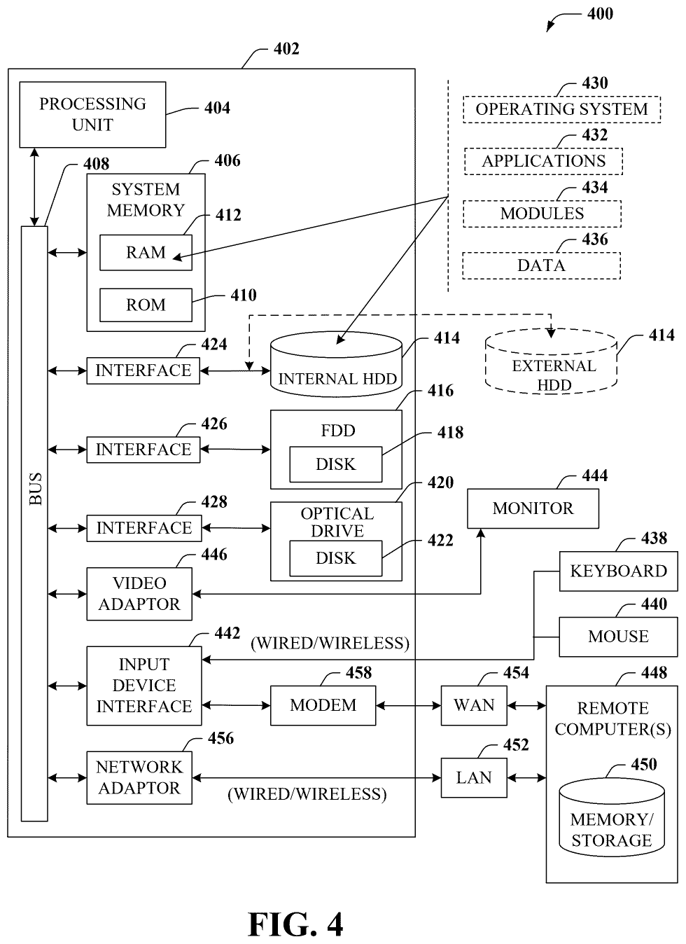

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. For example, computing environment 400 can facilitate, in whole or in part, dynamic UPMS with weighted jobs and balanced loads.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving information regarding a plurality of jobs;
assigning the plurality of jobs to a plurality of workers in accordance with a base schedule, wherein the base schedule is derived by solving an initial scheduling model that is configured to facilitate job assignments based on worker availability, capabilities, skills, experience, or a combination thereof, while reducing or minimizing job completion time and maintaining a determined balanced load;
detecting one or more disruptions or events after the assigning; and
causing the base schedule to be repaired based on the detecting, wherein the causing involves solving a scheduling repairing model that is configured to repair an existing schedule based on detected disruptions or events, while reducing or minimizing an impact of the detected disruptions or events on the existing schedule.

2. The device of claim 1, wherein the initial scheduling model and the scheduling repair model are implemented as two phases or components of an unrelated parallel machine scheduling (UPMS) system.

3. The device of claim 1, wherein the solving the initial scheduling model, the solving the scheduling repair model, or both are performed using a genetic algorithm (GA).

4. The device of claim 3, wherein the GA employs a custom initial seed that involves sorting the plurality of jobs in an ascending order based on job execution time, job weight, or a combination thereof, and allocating the plurality of jobs one at a time to workers of the plurality of workers that have the lowest load.

5. The device of claim 3, wherein the GA includes jump operations that prevent the GA from being trapped in local optima.

6. The device of claim 3, wherein the GA has a self-learning mechanism that implements jump selection based on a self-learning patience value.

7. The device of claim 1, wherein the base schedule comprises individual work lists for the plurality of workers based on worker availability, capabilities, skills, experience, or a combination thereof, rather than a single shared work list for the plurality of workers.

8. The device of claim 1, wherein the one or more disruptions or events comprise:
receipt of information regarding one or more additional jobs;
receipt of information regarding one or more defined high-priority jobs;
unavailability of one or more of the plurality of workers;
availability of one or more additional workers;
one or more of the plurality of jobs being completed;
a need for one or more completed jobs to be redone;
manual intervention with respect to the base schedule; or
a combination thereof.

9. The device of claim 1, wherein the scheduling repair model comprises a fitness function for penalizing repairs that deviate from the existing schedule.

10. The device of claim 1, wherein the assigning and the causing are performed based on an assumption that the plurality of workers are each capable of working on only one job at a time.

11. A non-transitory machine-readable medium, comprising executable instructions that, when executed by a processing system including a processor, facilitate performance of operations, the operations comprising:
assigning a plurality of jobs to a plurality of workers in accordance with a base schedule, wherein the base schedule is derived by solving an initial scheduling model that is configured to facilitate job assignments based on worker availability, capabilities, skills, experience, or a combination thereof, while reducing or minimizing job completion time and maintaining a determined balanced load;
detecting one or more disruptions or events after the assigning; and
causing the base schedule to be repaired based on the detecting, wherein the causing involves solving a scheduling repairing model that is configured to repair an existing schedule based on detected disruptions or events, while reducing or minimizing an impact of the detected disruptions or events on the existing schedule.

12. The non-transitory machine-readable medium of claim 11, wherein the initial scheduling model and the scheduling repair model are implemented as two phases or components of an unrelated parallel machine scheduling (UPMS) system.

13. The non-transitory machine-readable medium of claim 11, wherein the solving the initial scheduling model, the solving the scheduling repairing model, or both are performed using a genetic algorithm (GA).

14. The non-transitory machine-readable medium of claim 13, wherein the GA employs a custom initial seed that involves sorting the plurality of jobs in an ascending order based on job execution time, job weight, or a combination thereof, and allocating the plurality of jobs one at a time to workers of the plurality of workers that have the lowest load.

15. The non-transitory machine-readable medium of claim 13, wherein the GA includes jump operations that prevent the GA from being trapped in local optima.

16. A method, comprising:
identifying, by a processing system including a processor, a plurality of jobs that are to be assigned;
solving, by the processing system, an initial scheduling model that is configured to facilitate job assignments based on worker availability, capabilities, skills, experience, or a combination thereof, while reducing or minimizing job completion time and maintaining a determined balanced load, resulting in a base schedule;
assigning, by the processing system, the plurality of jobs to a plurality of workers in accordance with the base schedule;
causing, by the processing system, the base schedule to be repaired based upon detection of one or more disruptions or events, resulting in a repaired schedule; and
reassigning, by the processing system, some or all of the plurality of jobs to some or all of the plurality of workers based on the repaired schedule.

17. The method of claim 16, wherein the causing involves solving a scheduling repairing model that is configured to repair an existing schedule based on detected disruptions or events, while reducing or minimizing an impact of the detected disruptions or events on the existing schedule.

18. The method of claim 17, wherein the scheduling repair model comprises a fitness function for penalizing repairs that deviate from the existing schedule.

19. The method of claim 16, wherein the base schedule comprises individual work lists for the plurality of workers based on worker availability, capabilities, skills, experience, or a combination thereof, rather than a single shared work list for the plurality of workers.

20. The method of claim 16, wherein one or more of the solving, the assigning, the causing, and the reassigning are performed based on an assumption that the plurality of workers are each capable of working on only one job at a time.
